(19) United States
(12) Patent Application Publication
(10) Pub. No.: US 2019/0221389 A1
(43) Pub. Date: Jul. 18, 2019

(54) Multi-Configuration Mounting Adapter for Door Sensors

(71) Applicant: Bryan Buenaventura, San Mateo, CA (US)

(72) Inventor: Bryan Buenaventura, San Mateo, CA (US)

(21) Appl. No.: 16/238,481

(22) Filed: Jan. 2, 2019

Related U.S. Application Data
(60) Provisional application No. 62/617,269, filed on Jan. 14, 2018.

(51) Int. Cl. H01H 36/00; G08B 13/08

(52) U.S. Cl. CPC H01H 36/0033; G08B 13/08

(57) ABSTRACT

A multi configuration magnetic sensor mounting adapter comprising of a mounting adapter and a magnetic capsule to mount magnetic door sensors on a door or a door frame. At least four different configurations are possible using the combination of the magnetic capsule and the multi-configuration magnetic sensor mounting adapter to accommodate common scenarios of installation over the most common variety of door and door frame configurations for magnet sensor installation purposes. The mounting adapter also provides an installer with an adjustment feature that can be utilized to maintain within proper gapping tolerances in between sensor switch and magnet.

### CROSS REFERENCE TO RELATED APPLICATIONS

This Non-Provisional Patent Application claims priority to U.S. Provisional Patent Application No. 62/617,269 filed on Jan. 14, 2018.

### STATEMENT REGARDING FEDERALLY SPONSORED RESEARCH AND DEVELOPMENT

None.

### FIELD OF THE INVENTION

The present invention relates to a multi-configuration mounting adapter for magnetic door sensors installed on a door.

### BACKGROUND

An improved mounting adapter is provided for a magnetic door sensors and operating magnet which serves to enable magnetic door sensors, constructed to be mounted in a press fit relationship in wooden door frames and in wooden doors, also to be mounted in a self-locking relationship in steel doors and in steel door frames. This obviates the need for producing a first set of switches and associated magnets for installation in wooden doors and frames, and a second set for installation in steel doors and frames.

Magnetic switches and actuating magnets are widely used in alarm systems to respond and activate an alarm whenever the door in which they are mounted is opened by an unauthorized person. The improved adapter of the invention in a specific application permits the same size switches and actuator magnets to be used in conjunction with wooden doors and steel doors. This obviates the need to manufacture one line of switches for wooden doors and a second line for steel doors.

Magnetic switches are normally capable of virtually unlimited cycles of operation before failure. This is because the contacts of the magnetic switches are not exposed to corrosion from atmospheric conditions and there are no bearings to fail. Encapsulated magnetic contact switches have been used in the past in security systems and in position sensing applications because of this longevity and reliability.

When such switches are used in position-sensing application they are usually activated by the magnetic field of a permanent magnet which is movable with respect to the switch itself. The magnet is attached to one of two relatively movable objects, such as a door, while the switch itself is mounted on the other, such as the door frame.

As pointed out above, an objective of the present invention is to provide an improved adapter which is constructed to permit such switches which are constructed to be mounted in press fit relationship in relatively movable objects formed, for example, of wood or other pliable material; also to be mounted in a self-locking relationship in relatively movable objects formed, for example, of steel or other non-pliable material.

A general objective of the invention, accordingly, is to provide a mounting adapter which permits the same magnet switch and associated activating magnet assembly intended to be mounted in a press fit relationship in holes in a wooden door and wooden door frame and also to be mounted and locked in larger diameter holes in a steel door and steel door frame in a self-locking relationship that creates a very narrow magnetic field area of effect such that the switch cannot be tampered by an external magnetic source outside of the mounting adapter.

Door sensor switches and their corresponding actuation magnets are very sensitive to their gapping distances in between them. Some sensors may operate with a magnet as close together as 1/16″, and some as far as 1″ in between them. When gapping distances are exceeded (e.g. A 1.5″ gap distance for a sensor with a 1″ maximum gap tolerance), the probabilities of disfunction and false alarms would be inevitable.

Thus, against the backdrop of the problems identified above, this invention seeks to solve the problems identified in the existing prior art by creating a multi-configuration mounting adapter for a magnet switch that can work with multiple door configurations, and in providing an installer with an adjustment feature that can be utilized to maintain within proper gapping tolerances in between sensor switch and magnet.

### SUMMARY OF THE INVENTION

The present invention is directed to a multi-configuration magnetic sensor mounting adapter to cover several common scenarios presented by different door configurations available in the market today with the additional purpose of reducing false alarms due to poor or suboptimal installation scenarios, or simple wear and tear over time.

In one embodiment, a magnetic sensor capsule, for use with magnetic sensors, comprising an enclosure surrounding a magnetic rod-shaped element, said enclosure including a threaded outer portion adapted to engage a threaded cavity in an object, wherein said threaded outer portion enables longitudinal positioning of said magnetic rod-shaped element within said cavity when said enclosure is rotated around a longitudinal axis thereof with respect to said threaded cavity.

In another embodiment, A magnetic sensor capsule and mounting adapter therefor, for use with magnetic sensors, comprising an enclosure surrounding a magnetic rod-shaped element, said enclosure including a threaded outer portion adapted to engage a threaded cavity in said mounting adapter, wherein said threaded outer portion enables longitudinal positioning of said rod shaped magnet within said threaded cavity when said enclosure is rotated around a longitudinal axis thereof with respect to said threaded cavity, said mounting adapter being adapted for insertion into and retention in a second cavity in an object.

The adapter comprises of a multi-configuration magnetic sensor mounting adapter and a magnetic capsule that can be mounted independently from the multi-configuration magnetic sensor mounting adapter as needed.

The multi-configuration magnetic sensor mounting adapter comprises of a substantially cylindrical inner body, a substantially cylindrical outer body that envelopes the upper portion of the inner body, a flat surface covering both the outer body and the inner body, and a threaded hole to mount the magnetic capsule within the inner body.

The flat surface covering both the outer body and the inner body is provided with a lip to secure the mounting adapter on a hole so that the whole adapter does not fall through the hole. A plurality of flexible legs can be provided on the perimeter of the outer body circumference to further secure the mounting adapter in the hole. The flexible legs are further provided with a plurality of flexible leg steps to improve the friction fit of the mounting adapter and the surface of the cavity where the mounting adapter will be ultimately mounted.

The Magnetic Capsule comprises of a piece of magnet shaped like a rod, a threaded enclosure, wherein an outer lip and screwdriver tab are provided on the upper flat portion of the threaded enclosure.

In the preferred embodiment, at least four different configurations are possible using the combination of the magnetic capsule and the multi-configuration magnetic sensor mounting adapter.

In a simple wooden door configuration, the magnetic capsule can be used independently without the multi-configuration magnetic sensor mounting adapter by drilling a hole on the door or the frame, and followed by inserting the magnetic capsule using its threaded enclosure.

The second configuration involves drilling a hole on the door or the frame and inserting the multi-configuration adapter such that the top flat surface is flush with the surface of the door or the frame. The magnetic capsule is then inserted into the threaded hole of the multi-configuration adapter such that the adapter's flat surface and magnetic capsule's top flat surface are both flush and creates a tight seal.

The third configuration involves drilling a hole on the door or the frame and inserting the multi-configuration magnetic sensor mounting adapter such that inner body section of the multi-configuration magnetic sensor mounting adapter is fully inserted to the hole, but the outer body of the adapter sits immediately on the surface of the door or the frame. This configuration is typically found where the door or the frame has a channel such that installing the magnetic capsule flush inside the channel would prevent the magnet making actual contact because the distance between the magnet on the door and the magnet on the frame is too great for the magnets to reliably connect with one another.

The fourth configuration involves mounting the multi-configuration magnetic sensor mounting adapter in an inverted position such that the top flat surface of the adapter makes a full contact with the surface of the door. Adhesives may be applied to the top flat surface portion of the adapter to properly secure the adapter in place. The magnetic capsule is then in turn inserted from the threaded opening on the opposite side of the flat top surface of the adapter, and said magnetic capsule can be height adjusted until it is flush with the top edge of the door channel or the bottom portion of the inner body, whichever creates the most optimum contact with the opposing magnet when the door is in a closed position.

### BRIEF DESCRIPTION OF DRAWINGS

These and other features, aspects, and advantages of the present invention will become better understood with regard to the following descriptions, appended claims and accompanying drawings where:

FIG. 01 shows an exploded view of a possible configuration the Multi Configuration Magnetic Sensor Mounting Adapter and Magnet Capsule.

FIG. 02 shows an alternate exploded view of a possible configuration the Multi Configuration Magnetic Sensor Mounting Adapter and Magnet Capsule.

FIG. 03 shows a perspective view of the Multi Configuration Magnetic Sensor Mounting Adapter.

FIG. 04 shows an alternate perspective view of the Multi Configuration Magnetic Sensor Mounting Adapter.

FIG. 05 shows a top view of the Multi Configuration Magnetic Sensor Mounting Adapter.

FIG. 06 shows a bottom view of the Multi Configuration Magnetic Sensor Mounting Adapter.

FIG. 07 shows a side view of the Multi Configuration Magnetic Sensor Mounting Adapter.

FIG. 08 shows a perspective view of the Magnet Capsule.

FIG. 09 shows a side view of the Magnet Capsule.

FIG. 10 shows a perspective view of the Multi Configuration Magnetic Sensor Mounting Adapter with the Magnet Capsule inserted in said Adapter.

FIG. 11 shows an alternate perspective view of the Multi Configuration Magnetic Sensor Mounting Adapter with the Magnet Capsule inserted in said Adapter.

FIG. 12 shows a top view of the Multi Configuration Magnetic Sensor Mounting Adapter with the Magnet Capsule inserted in said Adapter.

FIG. 13 shows a bottom view of the Multi Configuration Magnetic Sensor Mounting Adapter with the Magnet Capsule inserted in said Adapter.

FIG. 14 shows a side view of the Multi Configuration Magnetic Sensor Mounting Adapter with the Magnet Capsule inserted in said Adapter.

FIG. 15 shows an exploded view of a possible configuration the Multi Configuration Magnetic Sensor Mounting Adapter and Magnet Capsule where the Mounting Adapter is in the inverted position.

FIGS. 16A and 16B show two alternate perspective views of a possible configuration the Multi Configuration Magnetic Sensor Mounting Adapter and Magnet Capsule where the Mounting Adapter is in the inverted position.

FIG. 17 shows a perspective view of a possible configuration the Magnet Capsule installed on a door.

FIG. 18 shows a side cutaway view of a possible configuration the Magnet Capsule installed on a door.

FIG. 19 shows a perspective view of a possible configuration the Multi Configuration Magnetic Sensor Mounting Adapter and Magnet Capsule installed on a door.

FIG. 20 shows a side cutaway view of a possible configuration the Multi Configuration Magnetic Sensor Mounting Adapter and Magnet Capsule installed on a door.

FIG. 21 shows a perspective view of a possible configuration the Multi Configuration Magnetic Sensor Mounting Adapter and Magnet Capsule installed on a door.

FIG. 22 shows a side cutaway view of a possible configuration the Multi Configuration Magnetic Sensor Mounting Adapter and Magnet Capsule installed on a door.

FIG. 23 shows a perspective view of a possible configuration the Multi Configuration Magnetic Sensor Mounting Adapter and Magnet Capsule installed on a door.

FIG. 24 shows a side cutaway view of a possible configuration the Multi Configuration Magnetic Sensor Mounting Adapter and Magnet Capsule installed on a door.

FIG. 25 shows an alternate side cutaway view of a possible configuration the Multi Configuration Magnetic Sensor Mounting Adapter and Magnet Capsule installed on a door.

FIG. 26 shows a side view of a Multi Configuration Magnetic Sensor Mounting Adapter positioned opposite to a door sensor switch at the minimum distance tolerance.

FIG. 27 shows a side view of a Multi Configuration Magnetic Sensor Mounting Adapter positioned opposite to a door sensor switch within the optimal distance tolerance.

FIG. 28 shows a side view of a Multi Configuration Magnetic Sensor Mounting Adapter positioned opposite to a door sensor switch outside the maximum distance tolerance.

### REFERENCE NUMBER INDEX

100—Mounting Adapter

101—Upper Flat Surface

102—Upper Lip

103—Outer Body

104—Tooling Slit

105—Inner Body

106—Flexible Leg

107—Leg Step

108—Threaded Hole

109—Bottom Flat Surface

200—Magnet Capsule

201—Threaded Housing Enclosure

202—Capsule Upper Flat Surface

203—Screwdriver Tab

204—Magnet Piece

300—Door

400—Door Sensor Switch

### DETAILED DESCRIPTION OF THE PREFERRED EMBODIMENT

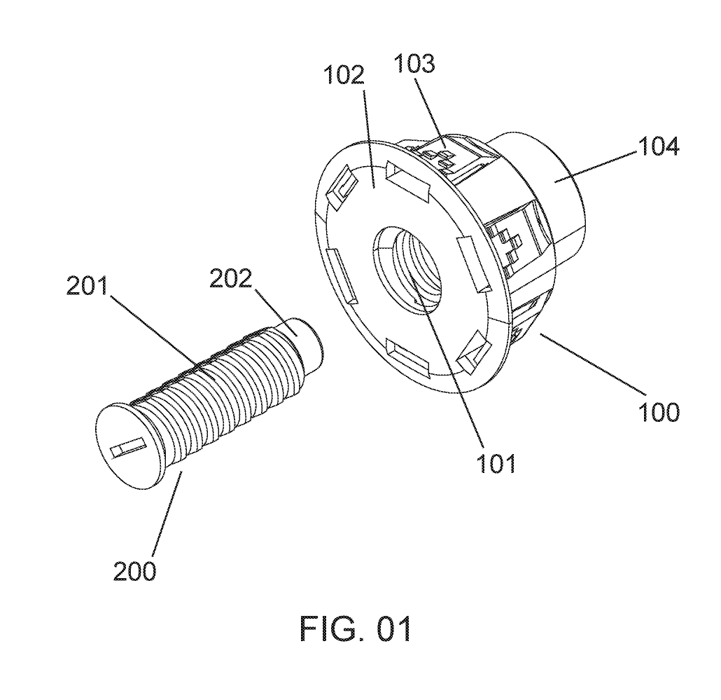

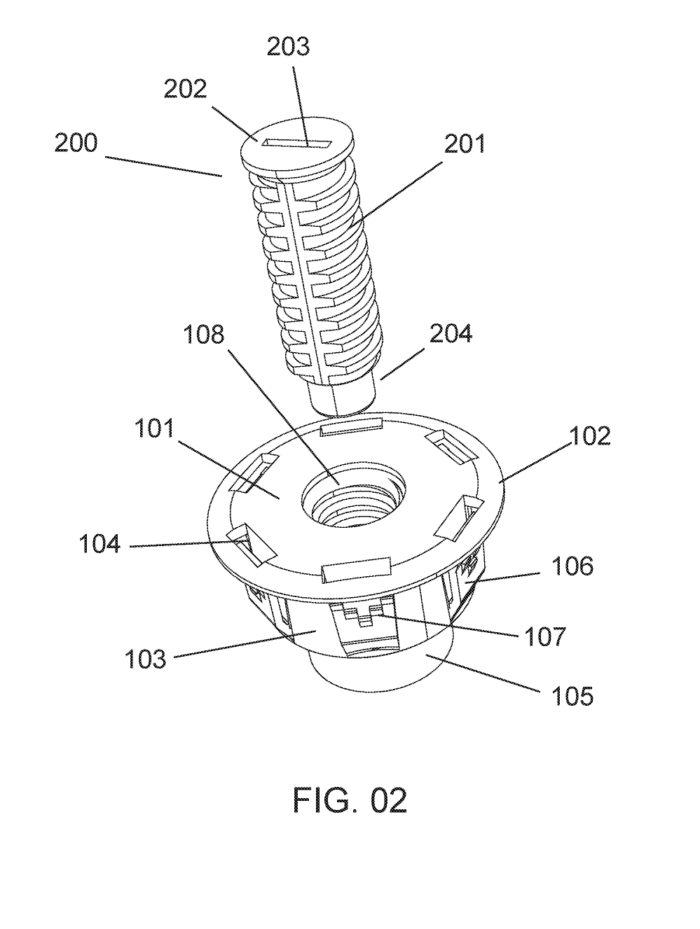

FIGS. 01 and 02 show perspective views of the Multi Configuration Magnetic Sensor Mounting Adapter which comprises of the Mounting Adapter 100 and the Magnetic Capsule 200.

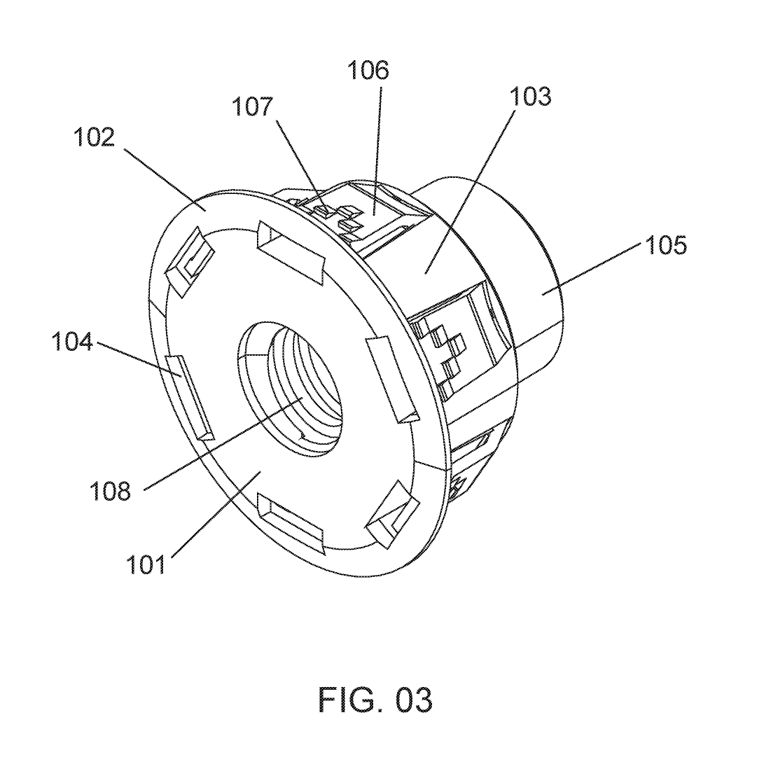

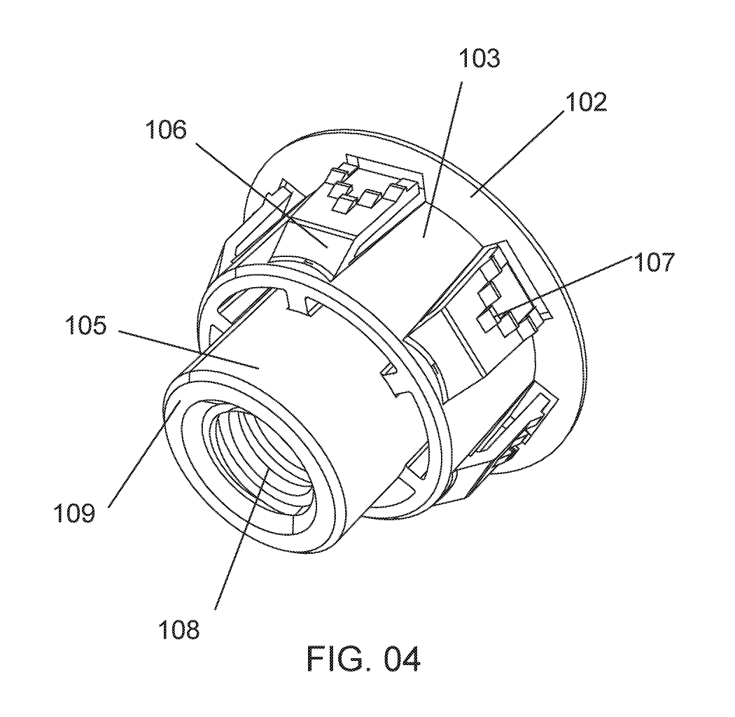

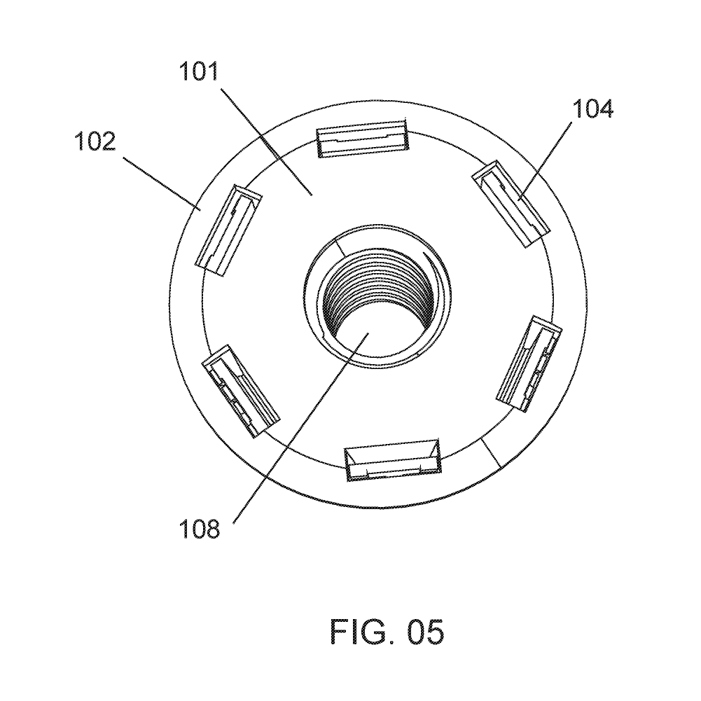

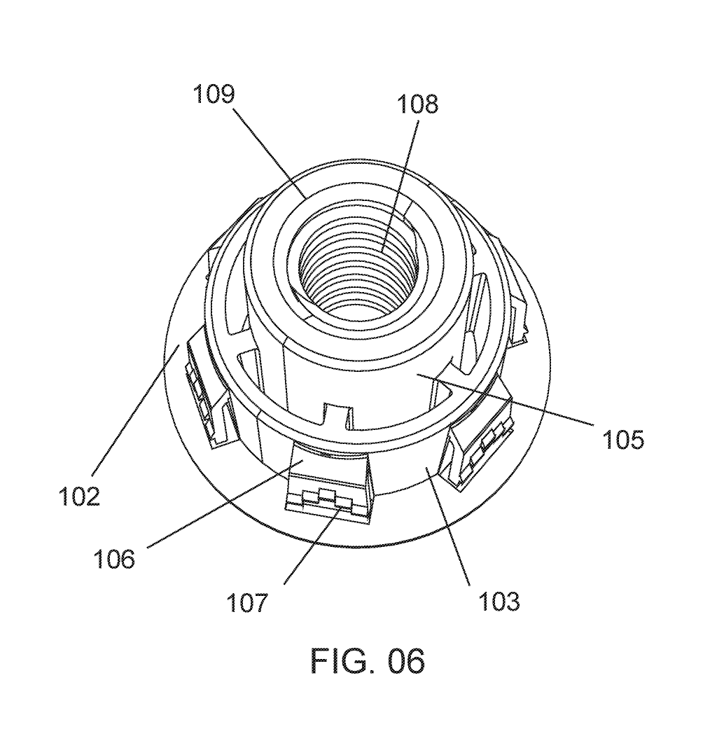

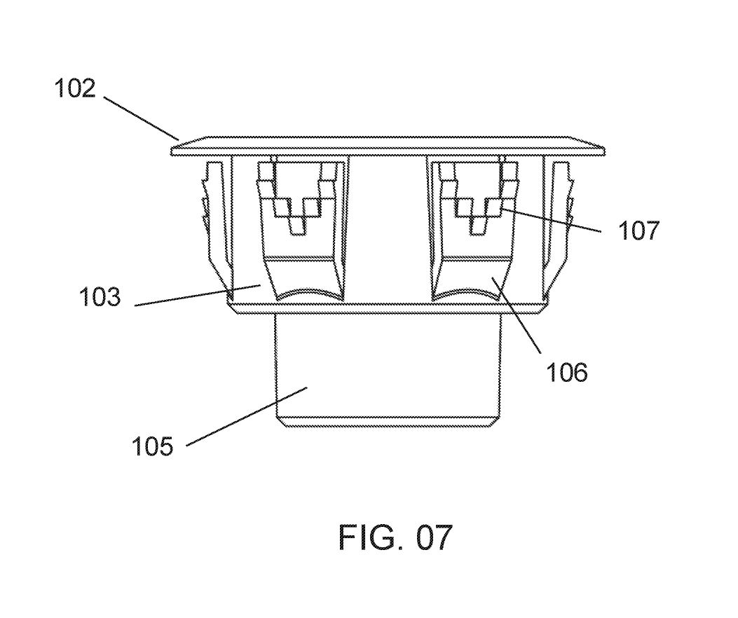

FIGS. 03 through 07 show views of the Mounting Adapter and its various parts from several viewing angles. The mounting adapter 100 comprises of an inner body 105 in which the upper portion of said inner body is layered with an outer body 103 creating an ice-cream cone like structure. A threaded hole 108 is provided on the center of the inner body. A flat surface 101 is provided on the upper portion of the outer body 103. The diameter of the flat surface 101 is slightly larger than the diameter of the outer body 103, creating a lip 102 which allows the mounting adapter to be inserted into the hole without having the entire mounting adapter fall through the hole. A plurality of slits may be added to the flat surface 101 to improve adhesion by allowing adhesives to enter into the slits and create further grip when the mounting adapter is installed in an inverted position. A plurality of flexible legs 106 are provided on the perimeter surface of the outer body 103 to ensure a friction fit is achieved between the mounting adapter and the surface of the hole, thereby preventing the mounting adapter from slipping out of the hole during installation. A plurality of leg steps can be further provided on the flexible legs 106 to act as fastening anchors to further prevent the mounting adapter from slipping out of the hole during installation and/or use.

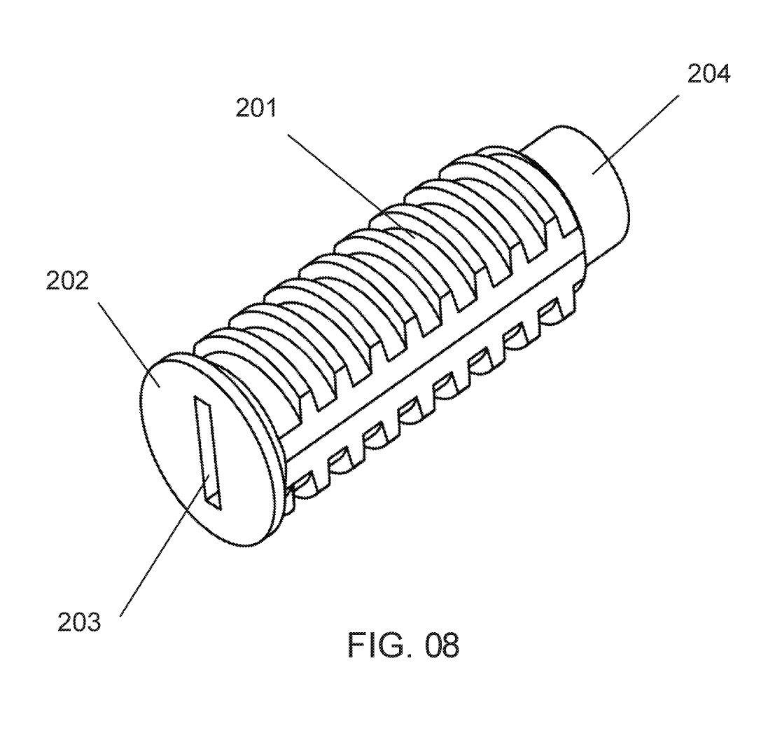

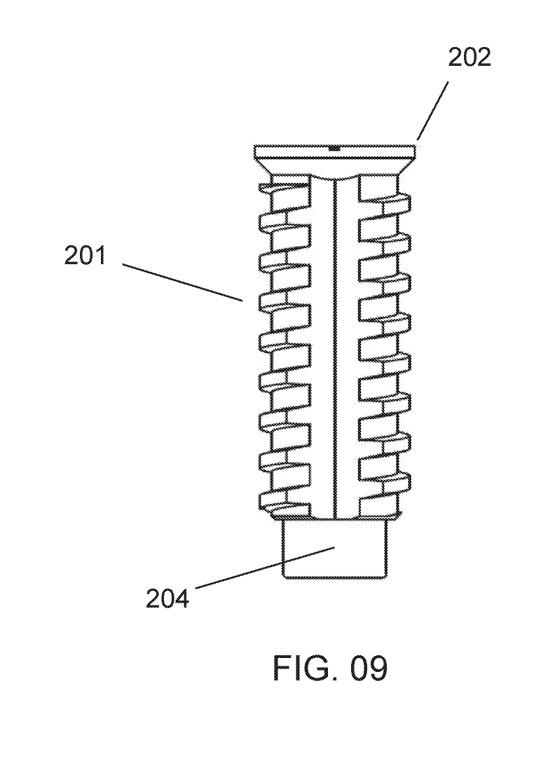

FIG. 08 shows a perspective view of the Magnet Capsule, and FIG. 09 shows a side view of the Magnet Capsule. The magnet capsule 200 comprises of a threaded enclosure 201 enveloping a rod-shaped magnet 204. The threaded enclosure 201 further features a flat upper surface 202 which may have a screwdriver tab 203. The threads on the Magnet Capsule is bidirectional such that it can be inserted from either end of the threaded hole 108 of the Mounting Adapter to allow the multiple configuration of the preferred embodiment.

The threaded nature of the Magnet Capsule also allows the Capsule's height to be adjusted post installation by screwing or unscrewing the Capsule to adjust height accordingly.

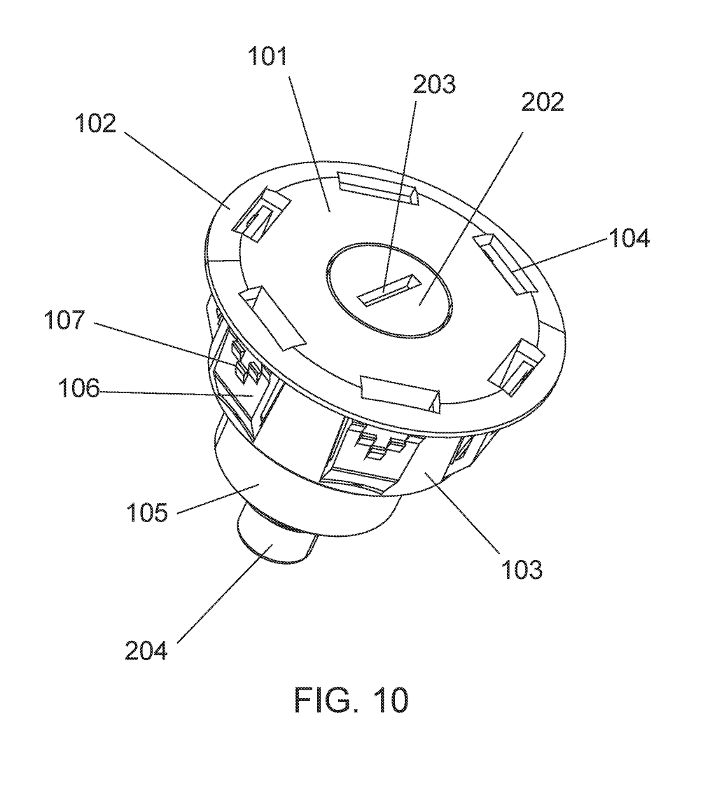

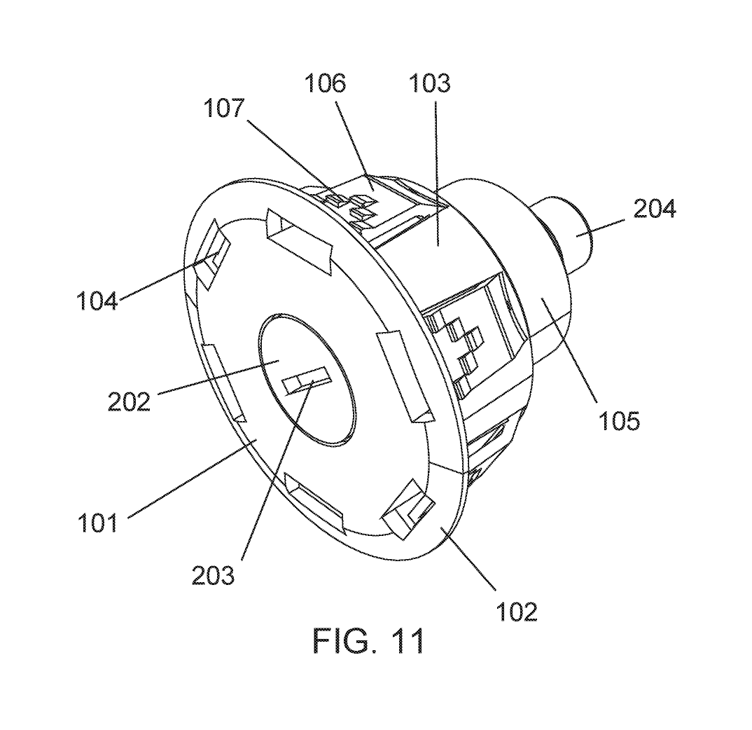

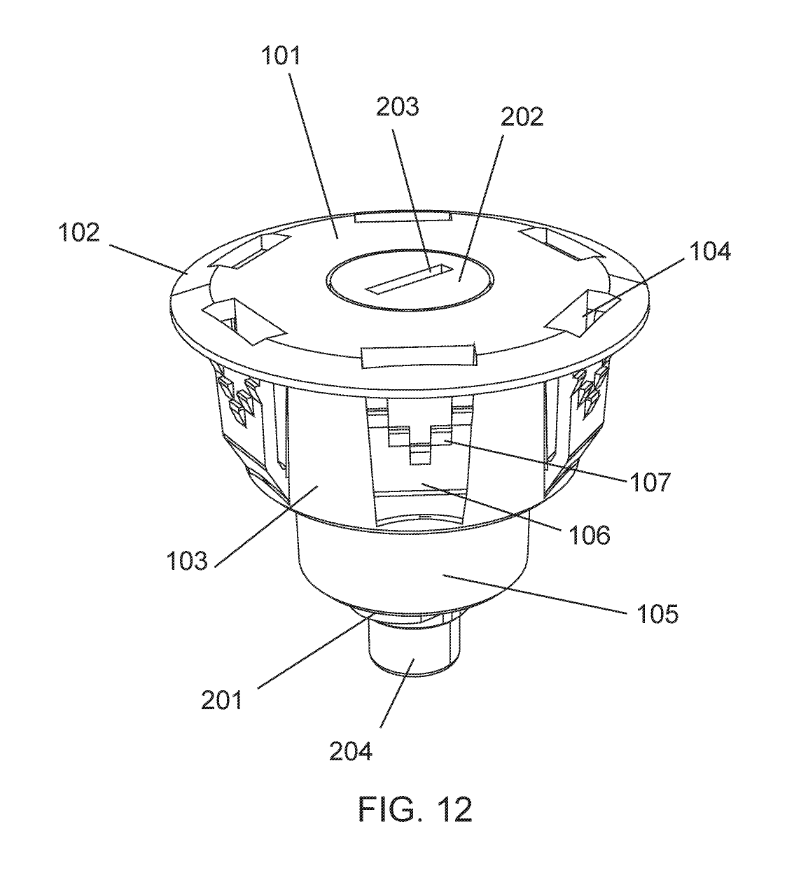

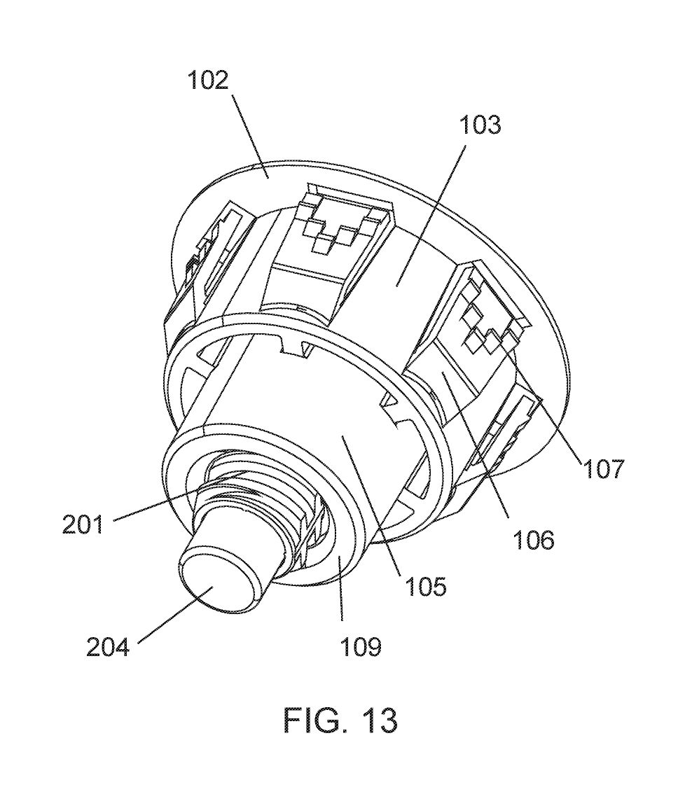

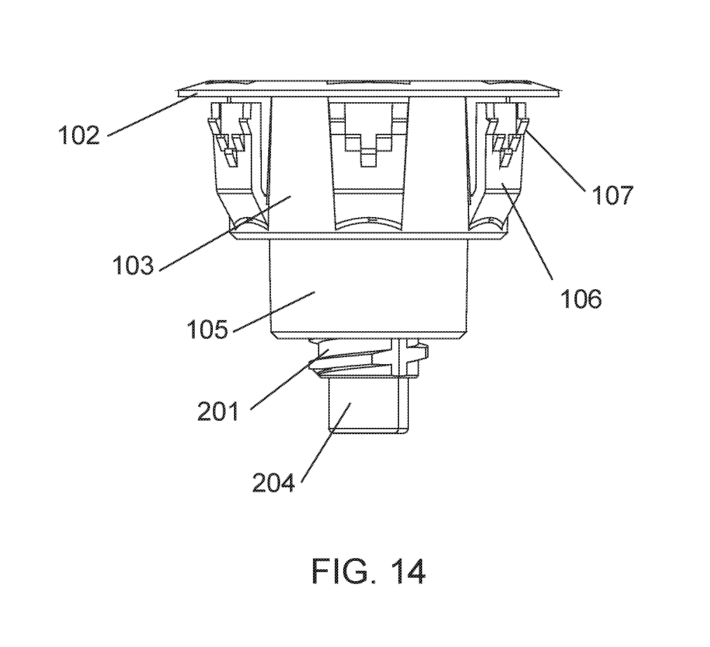

FIGS. 10 through 14 show views of the Mounting Adapter and Magnet Capsule inserted into the Adapter where the top flat surface of the Mounting Adapter 101 is flush with the top flat portion of the Magnet Capsule 202.

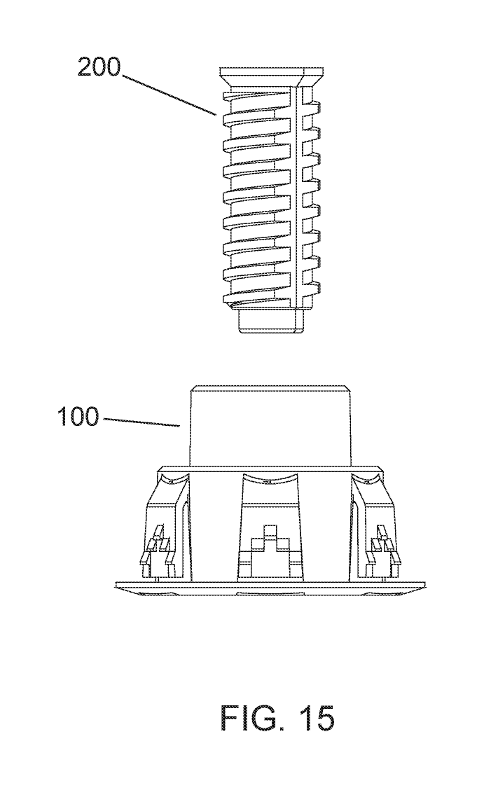

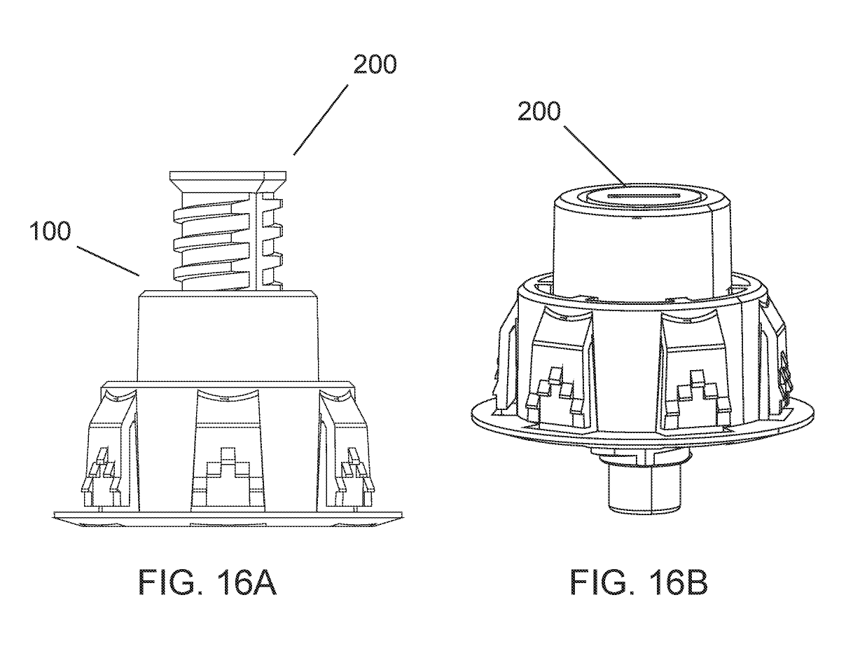

FIGS. 15, 16A and 16B show alternate perspective views of a possible configuration the Mounting Adapter and Magnet Capsule where the Mounting Adapter is in the inverted position relative to the Magnet Capsule. The Magnet Capsule can be inserted into the threaded hole from the opposite side of the flat surface 101, effectively creating a raised platform for the magnetic piece inside the magnet capsule for door configuration in which the upper portion of the door includes a recessed channel such that installing a magnetic sensor requires a third-party solution or modification to the door's surface.

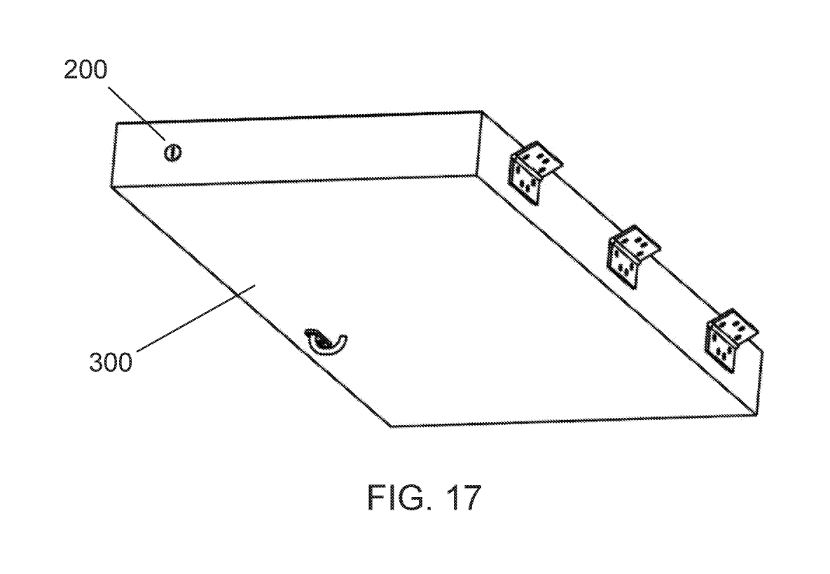

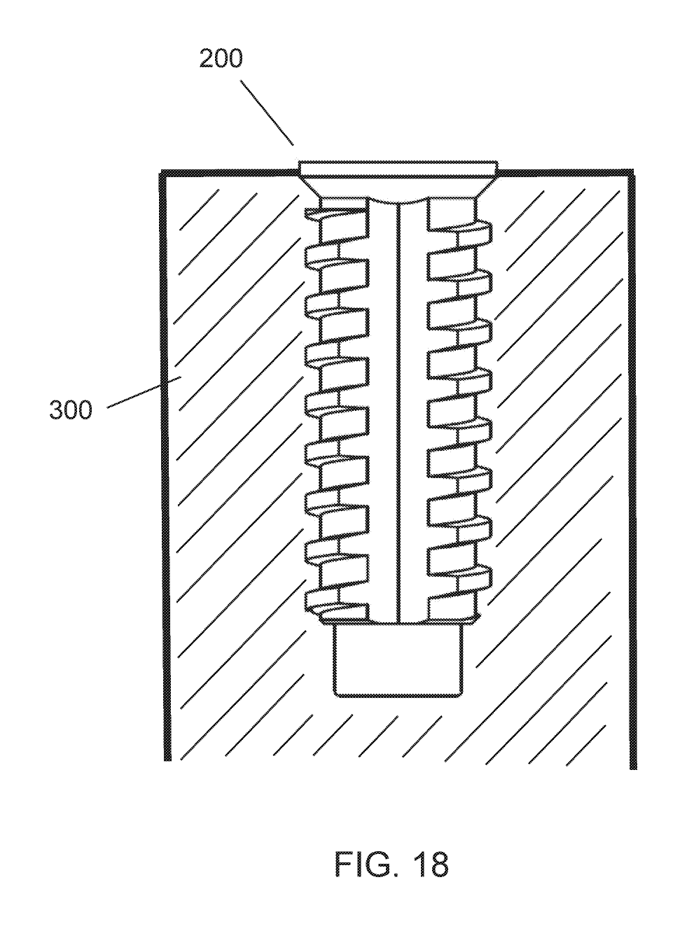

FIG. 17 shows a perspective view of a possible configuration the Magnet Capsule installed on a door in which only the Magnet Capsule 200 is inserted to the door, while FIG. 18 shows a side cutaway view of a possible configuration the Magnet Capsule installed on a door. This configuration is the simplest configuration and possible for typical wooden door applications where the mounting adapter is not necessary to achieve full contact with the opposite sensor on the door frame.

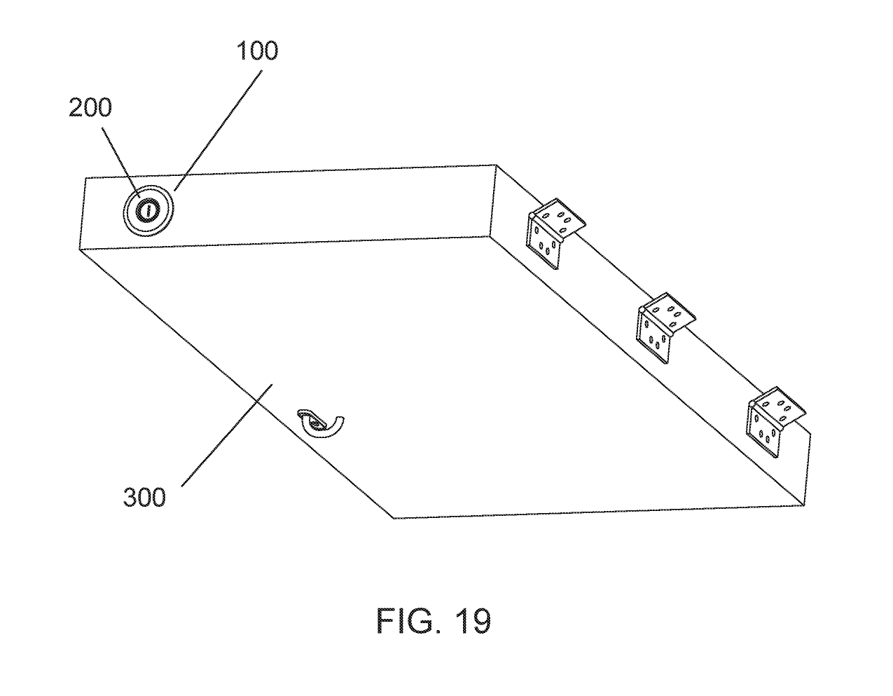

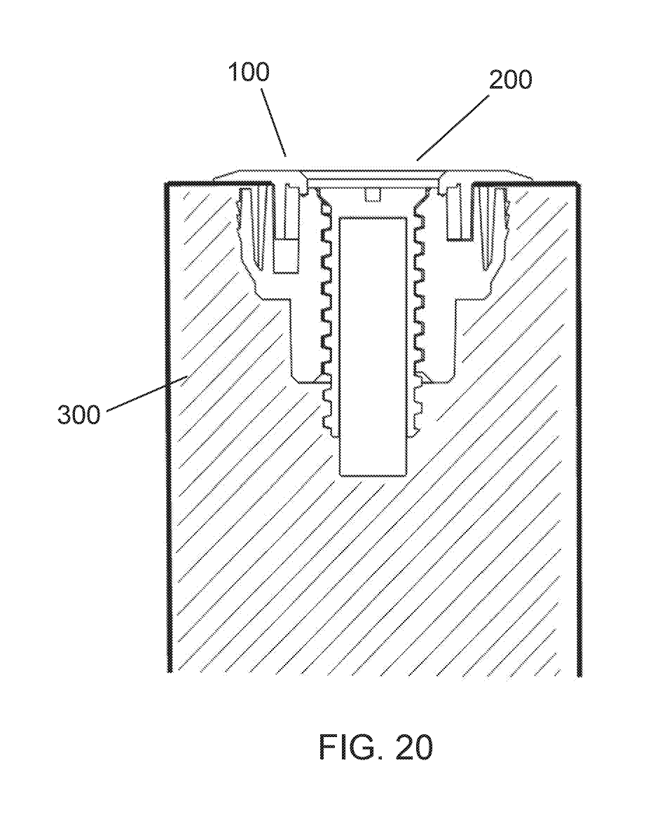

FIG. 19 shows a perspective view of a possible configuration the Mounting Adapter and Magnet Capsule installed on a door in which the mounting adapter is installed flush with the top of the door, and the Magnet Capsule is inserted to the Mounting Adapter. FIG. 20 shows a side cutaway view of a said configuration the Mounting Adapter and Magnet Capsule installed on a door depicted in FIG. 19.

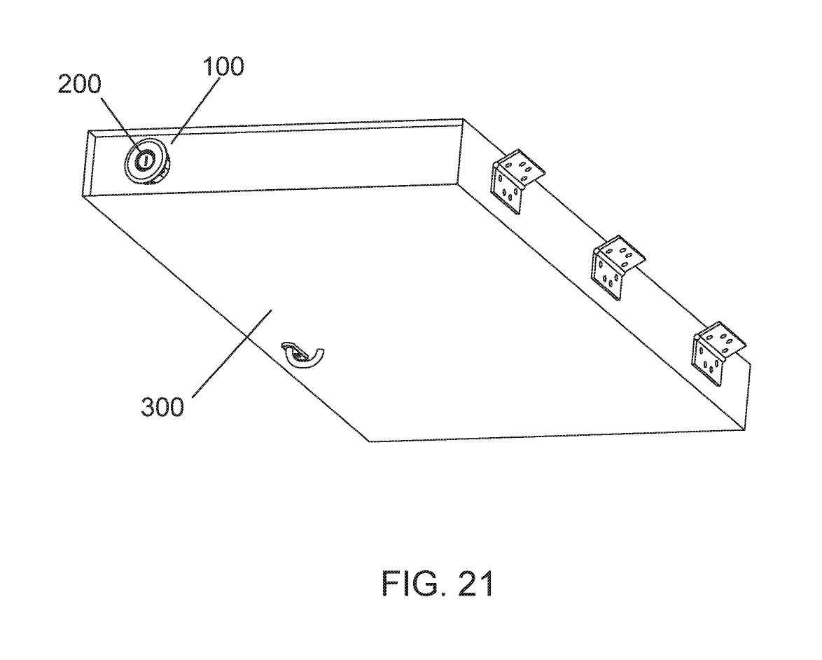

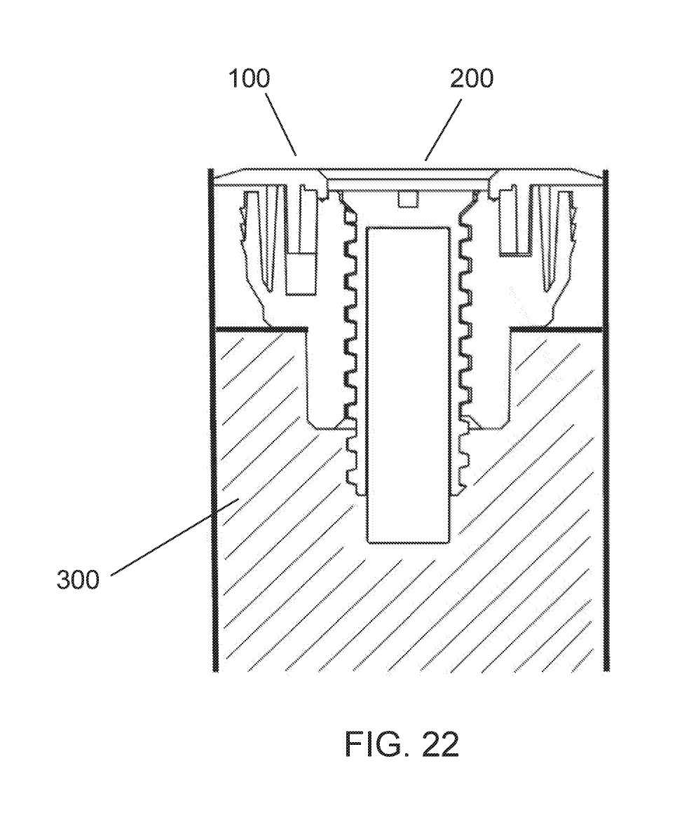

FIG. 21 shows a perspective view of a possible configuration the Mounting Adapter and Magnet Capsule installed on a door where the mounting adapter 100 is installed in a partially raised configuration to accommodate the depth of the channel in the upper portion of the door 300, while FIG. 22 shows a side cutaway view of the Mounting Adapter 100 and Magnet Capsule 200 installed on a door 300 in said configuration. In this configuration, the mounting adapter is inserted into a previously drilled hole in which the inner body 105 is fully inserted into the hole, while the outer body 103 sits on top of the surface of the door's channel. The magnet capsule 200 is then inserted to the threaded hole 108 and set flush with the upper flat surface 101 portion of the mounting adapter 100.

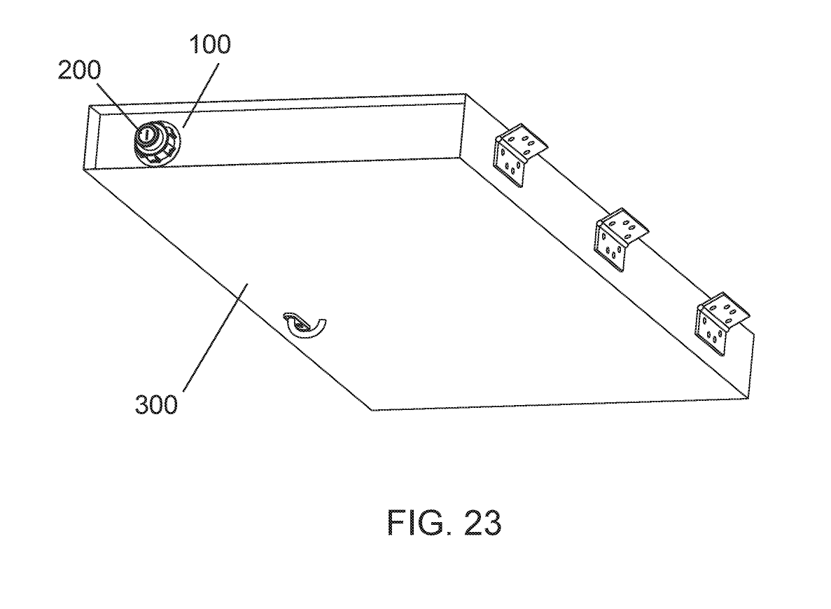

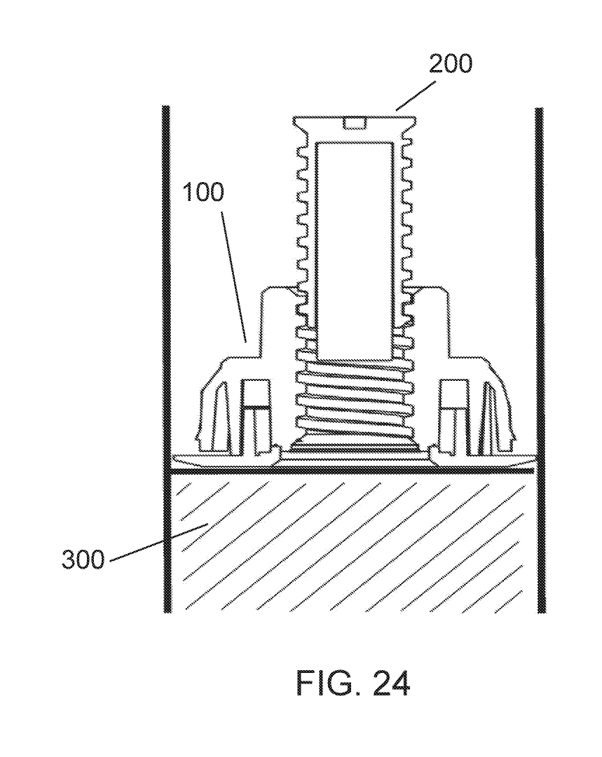

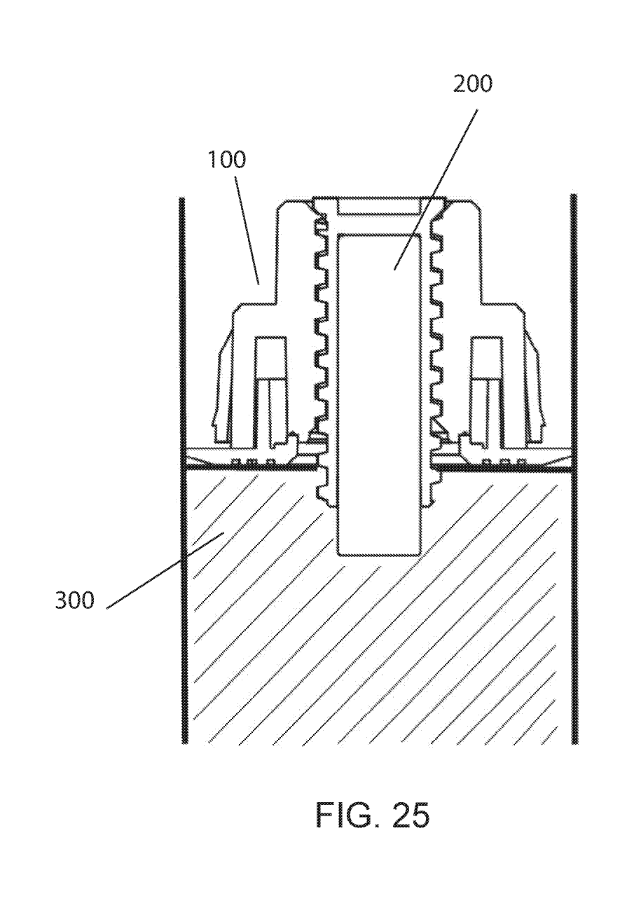

FIG. 23 shows a perspective view of a possible configuration the Mounting Adapter and Magnet Capsule installed on a door. In this configuration, the mounting adapter 100 is invertably mounted in order to give a raised platform for the magnetic capsule 200 because of the adapter being mounted in the recessed portion of the door's 300 channel. This configuration is commonly seen in doors made of metal including aluminum doors commonly found in commercial buildings. In this inverted adapter configuration, there are at least two variations of the height of the magnetic adapter 200 depending on the depth of the channel on the upper portion of the door 300. FIG. 24 shows a side cutaway view of the configuration where the magnetic capsule 200 is flush with the top portion of the door's 300 channel, while FIG. 25 shows a side cutaway view of another possible configuration the Mounting Adapter and Magnet Capsule installed on a door where the magnetic capsule 200 is flush with the flat portion of the inner body of the mounting adapter 100.

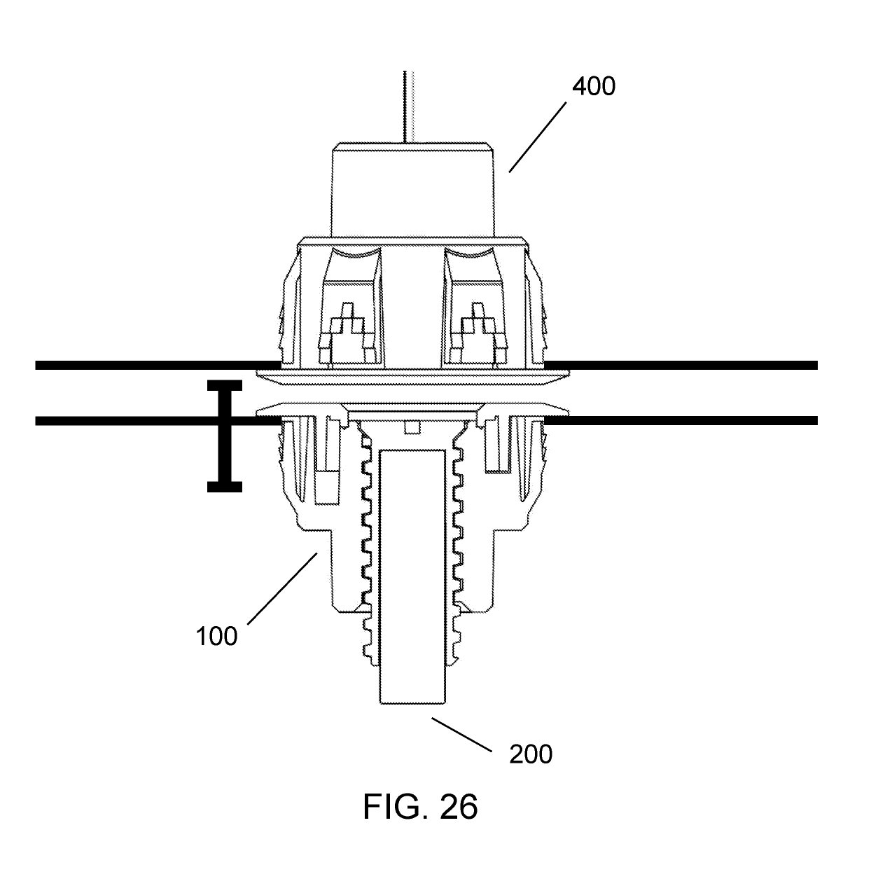

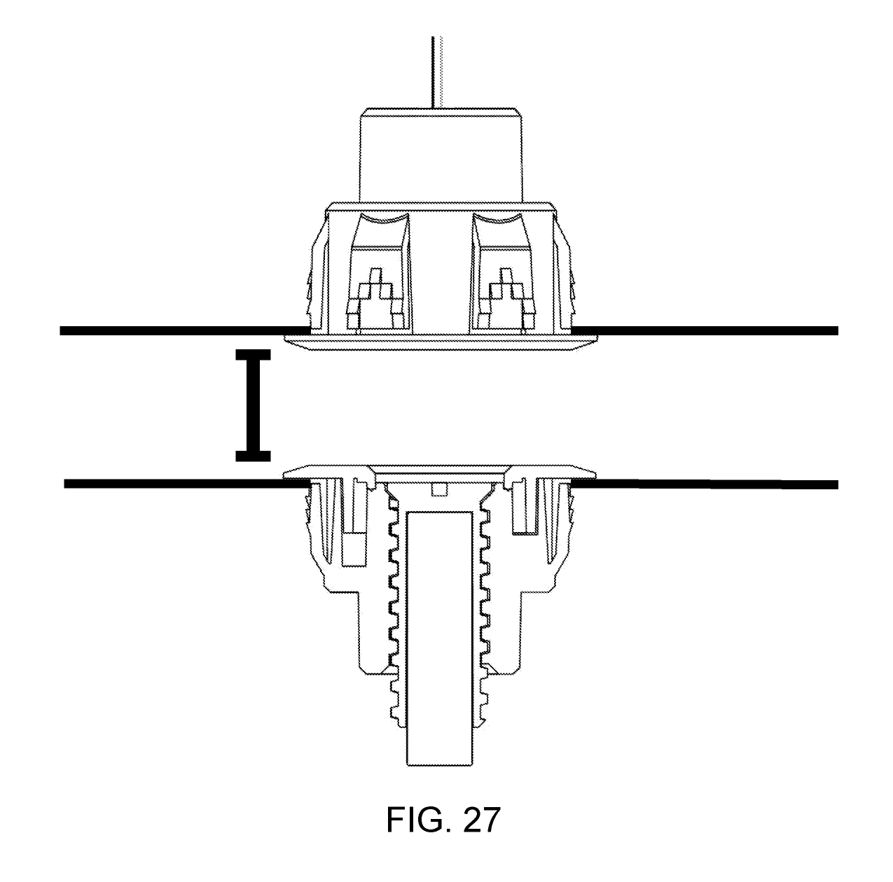

FIG. 26 shows a side view of a Multi Configuration Magnetic Sensor Mounting Adapter 100 positioned opposite to a door sensor switch 400 at the minimum distance tolerance when the door is in the closed position. For proper and optimum configuration such that the door sensor switch can reliably detect the magnet inside the adapter, the magnet capsule must be within the distance tolerance where the magnet can be reliably read by the door sensor switch. FIG. 27 shows a side view of a Multi Configuration Magnetic Sensor Mounting Adapter positioned opposite to a door sensor switch within the optimum gap distance.

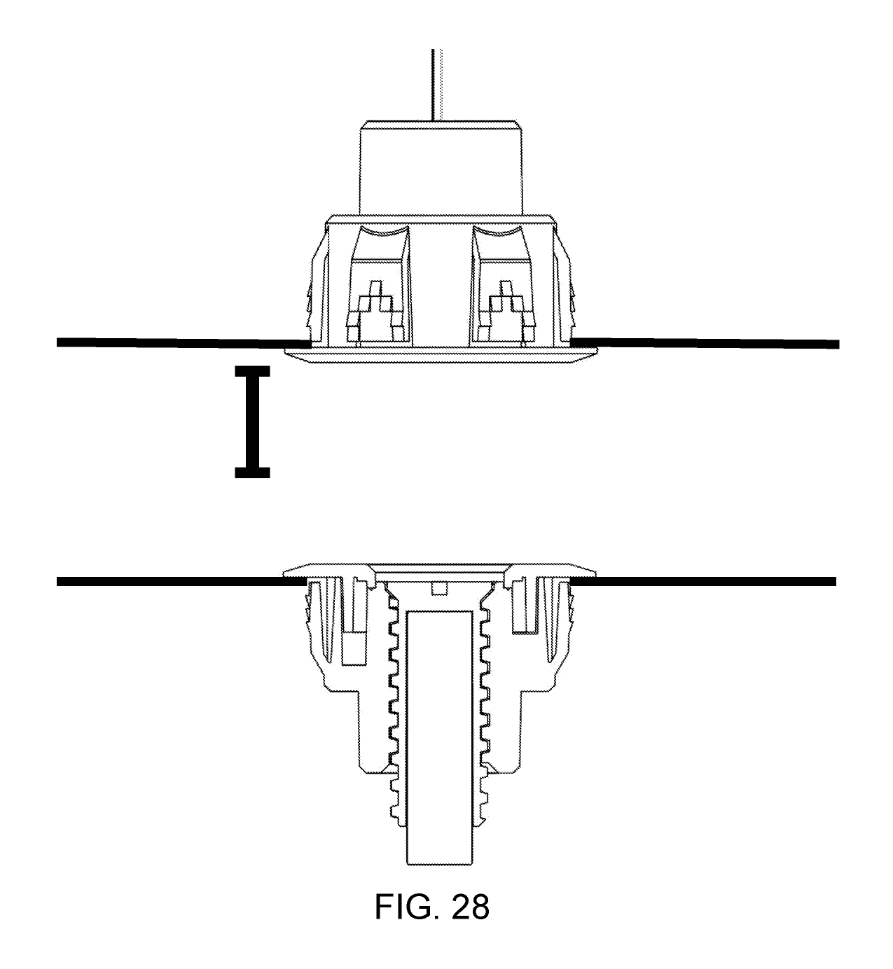

On the other hand, the door sensor switch's reliability to read the magnet sensor diminishes considerably if the magnet is positioned outside of the maximum distance tolerance. At this stage, the door sensor switch cannot reliably sense the magnetic forces emanating from the magnetic capsule, resulting in false positives where the door sensor switch does not recognize the door is actually in a closed position. FIG. 28 shows a side view of a Multi Configuration Magnetic Sensor Mounting Adapter positioned opposite to a door sensor switch outside the optimum gap distance.

In the Summary of the Invention above and in the Detailed Description of the Invention, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

Although the present invention has been described in considerable detail with reference to certain preferred versions thereof, other versions are possible. Therefore, the spirit and scope of the appended claims should not be limited to the description of the preferred version contained herein.

We claim:

1. A magnetic sensor capsule, for use with magnetic sensors, comprising:
an enclosure surrounding a magnetic rod-shaped element, said enclosure including a threaded outer portion adapted to engage a threaded cavity in an object, wherein said threaded outer portion enables longitudinal positioning of said magnetic rod-shaped element within said cavity when said enclosure is rotated around a longitudinal axis thereof with respect to said threaded cavity.

2. A magnetic sensor capsule as in claim 1, wherein:
said object is a mounting adapter including said threaded cavity, said mounting adapter being adapted for insertion into and retention in a second cavity in a second object.

3. A magnetic sensor as in claim 3, wherein:
said mounting adapter includes an inner and an outer body, said inner body including said threaded cavity, and said outer body including a lip portion adapted to maintain a substantially flush insertion of said outer body into said second object and prevent said outer body from passing into said second object.

4. A magnetic sensor as in claim 3, wherein:
said adapter includes at least one flexible leg element attached to, and extending radially with respect to said axis.

5. A magnetic sensor as in claim 4, wherein:
said flexible leg element further includes steps on a surface thereof oriented radially from said axis to enhance interference between said leg and said second cavity in said second object.

6. A magnetic sensor as in claim 5, wherein:
each of said outer body lip and said enclosure include flat surfaces such that said respective flat surfaces may be made co-planar such that a substantially flush mount to said second object may be achieved.

7. A magnetic sensor as in claim 6, wherein:
said enclosure includes one of said flat surfaces on each respective end of said enclosure, each said surface on said enclosure including a screw driver tab adapted to twist said enclosure and adjust a longitudinal position thereof in said threaded cavity.

8. A magnetic sensor capsule and mounting adapter therefor, for use with magnetic sensors, comprising:
an enclosure surrounding a magnetic rod-shaped element, said enclosure including a threaded outer portion adapted to engage a threaded cavity in said mounting adapter, wherein said threaded outer portion enables longitudinal positioning of said rod shaped magnet within said threaded cavity when said enclosure is rotated around a longitudinal axis thereof with respect to said threaded cavity, said mounting adapter being adapted for insertion into and retention in a second cavity in an object.

9. A magnetic sensor capsule and mounting adapter, as in claim 8, wherein:
said mounting adapter includes an inner and an outer body, said inner body including said threaded cavity, and said outer body including a lip portion adapted to maintain a substantially flush insertion of said outer body into said object and prevent said outer body from passing into said object.

10. A magnetic sensor capsule and mounting adapter, as in claim 9, wherein:
said adapter includes at least one flexible leg element attached to, and extending radially with respect to said axis.

11. A magnetic sensor capsule and mounting adapter, as in claim 10, wherein:
said flexible leg element further includes steps on a surface thereof oriented radially from said axis to enhance interference between said leg and said second cavity in said object.

12. A magnetic sensor capsule and mounting adapter, as in claim 11, wherein:
each of said outer body lip and said enclosure include flat surfaces such that said respective flat surfaces may be made co-planar such that a substantially flush mount to said object may be achieved.

13. A magnetic sensor capsule and mounting adapter, as in claim 12, wherein:
said enclosure includes one of said flat surfaces on each respective end of said enclosure, each said surface on said enclosure including a screw driver tab adapted to be used to twist said enclosure and adjust a longitudinal position thereof in said threaded cavity.
